(19) United States
(12) Patent Application Publication
(10) Pub. No.: US 2002/0061769 A1
(43) Pub. Date: May 23, 2002

(54) Device for displaying information

(76) Inventors: Christoph Bartelmus, Saarbrucken (DE); Andreas Butz, Saarbrucken (DE); Antonio Kruger, Saarbrucken (DE)

Correspondence Address: HENRY M FEIEREISEN, 350 FIFTH AVENUE, SUITE 3220, NEW YORK, NY, 10118, US

(21) Appl. No.: 09/788,750

(22) Filed: Feb. 20, 2001

(30) Foreign Application Priority Data
Nov. 21, 2000 (DE) DE 200 19 794.0

(51) Int. Cl. H04B 1/38

(52) U.S. Cl. 455/566; 455/500; 455/575; 379/56.1

(57) ABSTRACT

An information-displaying device includes a portable receiver configured for receiving transmitter-specific information by wireless data transmission in an infrared range, and a plurality of transmitters provided for transmission of the transmitter-specific information, whereby the transmitter-specific information is transmittable from the transmitters by a data transfer between the transmitters and/or a data transfer from a communications unit to the transmitters.

### CROSS-REFERENCES TO RELATED APPLICATIONS

This application claims the priority of German Patent Application Serial No. DE 200 19 794.0, filed Nov. 21, 2000, the subject matter of which is incorporated herein by reference.

### BACKGROUND OF THE INVENTION

The present invention relates, in general, to information-displaying devices, and, more particularly, to an information-displaying device of a type in which transmitter-specific information is receivable by a receiver by wireless data transmission in the infrared range.

According to a project conducted by the Fraunhofer Institute in Rostock, Germany, individual objects (for example, at an exhibition) are provided with an infrared transmitter, and small computers are designed as receivers. When the receivers pick up specific infrared signals, information is outputted that had been stored previously in the small computer and assigned to the specific infrared signals. Thus, the infrared signals can be used to control which particular information is displayed by the small computer.

The company lesswire AG in 15236 Frankfurt/Oder, Germany developed a system called “LocalNavigator”, in which data is transmitted by way of radio signals. A bi-directional data exchange can also be effected by means of infrared signals, as known from German Pat. No. DE 35 33 705 A1. Thus, in this system, each device is designed as a transceiver.

It would be desirable and advantageous to provide an improved device for data transmission, whereby information is transferred more efficiently and relates directly to the user's specific location.

### SUMMARY OF THE INVENTION

The present invention provides for an information-displaying device, which includes a portable receiver configured for receiving transmitter-specific information by wireless data transmission in an infrared range, and a plurality of transmitters provided for transmission of the transmitter-specific information, whereby the transmitter-specific information is transmittable from the transmitters by a data transfer between the transmitters and/or a data transfer from a communications unit to the transmitters. The transmitter-specific information is communicated from the transmitters in the form of infrared signals.

As a result of an information-displaying device according to the present invention, it is particularly easy to localize the information such that it relates directly to the user's specific location. This is because infrared signals do not spread out over a large area. The area over which signals from a transmitter can be received can be limited additionally through use of screens. Once the user has left a certain area surrounding a transmitter, information from this transmitter can no longer be received. If the user is in a room where, for example, transmitters of this kind are mounted on two opposite walls, the direction of the user's vision can also be taken into account. If the user, holding the receiver in front of himself, turns his back on one of the transmitters, the transmitter now behind him can no longer communicate any information to the receiver. The user will now receive information from the opposite transmitter, i.e. the one now in front of him. Information can be localized very effectively in this way.

With a conventional system that uses radio signals to communicate information, selection of the information received is, at best, inaccurate. It is not possible to take into account which way the user is facing, and therefore his line of vision cannot be taken into account either.

As the transmitter-specific information which can be transmitted from the transmitters is changeable by way of data transfer between transmitters and/or by a data transfer from a communications unit to the transmitters, such information can be updated at short notice. This data transfer can be realized by interconnecting the transmitters by a data bus. All the available information is sent along the data bus, with the addresses of the individual transmitters assigned to data packets, so that each transmitter knows which data packet is supposed to be transmitted. Instead of wiring, a radio link can also serve to interconnect the transmitters.

The communications unit can be designed as a central processing unit, with each of the transmitters connected to the central processing unit by cable or radio link. In this case, the information for the individual transmitters can be updated by the central processing unit.

The communications unit may be formed, for example, by an infrared transmitter. In this case, information is updated by bringing the communications unit into the vicinity of the individual transmitters, so that the data from the communications unit can be received by reception components of the individual transmitters. These reception components of the individual transmitters likewise receive in the infrared range.

The communications unit may also, for example, include a microchip for storage of the updated information. Data transfer can be effected by providing each of the transmitters with a reader for the microchip. When the chip is inserted into the reader, the data in the respective transmitter is updated.

The exemplified embodiments outlined above show that the particular technical implementation of the communications unit is secondary for the present invention.

Compared to the “Mobis” system developed by the Fraunhofer Institute in Rostock and described above, the present invention has an advantage. The “Mobis” system requires that initially all information is stored in the receivers. The information is then communicated in location-specific portions. If the information needs to be updated, the altered information has to be stored again in all the receivers. With receivers that have already been handed out to users who are moving around the building, this cannot be done until the receivers are returned. The “Mobis” system thus does not permit updating of information on short notice.

The transmitters and receivers can be realized, for example, by using the “IrDA” interface protocol, which was developed for data transmission by means of infrared signals and accordingly enjoys widespread use. This also applies, for example, to small/handheld computers with an infrared interface, which in this case can also be used to advantage as a receiver. This frees a museum from the absolute necessity of providing receivers, since the visitors can use their own small/handheld computers as receivers. Examples of small/handheld computers are palmtops and laptops. It is also possible to use an interface protocol other than the “IrDA”. It is expedient, however, to use one that enjoys widespread use, so that visitors can use their own equipment.

Instead of small/handheld computers, it is also possible to use mobile telephones or similar equipment. Since the information is communicated unidirectionally from the transmitters to the receivers, the interface protocol need only be exploited at one of the lower levels or at the lowest level. In this way maximum availability and flexibility is obtained with respect to the equipment used for reception. An added benefit of the unidirectional communication of information is that a plurality of receivers can receive the information at the same time.

The system known from German Pat. No. DE 35 33 705 is also disadvantageous because the transmitters and receivers have to go through a recognition process when a receiver comes into the reception range of a transmitter. For the duration of this recognition process, the transmitter is blocked for other receivers. Reception of the information by several receivers at more or less the same time is thus not possible. An added disadvantage is that receivers which also have to operate as transmitters (i.e. transceivers) are more complex. The fact that they have to transmit data increases their power consumption and puts a greater load on the accumulators in the portable receiver. Another disadvantage of this conventional system is the need to stock a sufficient number of receivers for users.

According to another feature of the present invention, the information can be displayed by the receiver. The information is thus immediately available to the user, making the system especially suitable as a guide through museums or exhibitions. Apart from a visual display, the information may also be communicated in audible form.

According to another feature of the present invention, the information can be stored by the receiver. In this case, the information can be further processed. This can be effected directly by the receiver. Alternatively, the information can be relayed by the receiver to another piece of equipment for further processing of the information.

According to another feature of the present invention, the receiver may have a processing unit in which received information can be processed. The versatility of the receiver is increased as a result.

According to another feature of the present invention, the receiver may be a mobile telephone. This has the advantage that a standardized infrared mobile telephone interface can be used. Since mobile telephones enjoy widespread use, the advantage here is that users can use their own telephones as receiver. As a result, the system is altogether cheaper to implement.

According to another feature of the present invention, the receiver may be a portable computer. Portable computers are also widely used, so that here too, users can make direct use of their own equipment.

The use of a standardized interface is especially beneficial if users employ their own equipment.

### BRIEF DESCRIPTION OF THE DRAWING

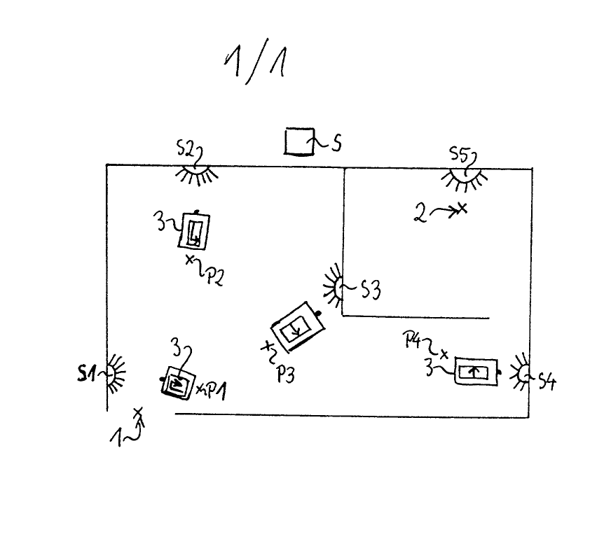

Other features and advantages of the present invention will be more readily apparent upon reading the following description of a preferred exemplified embodiment of the invention with reference to the accompanying drawing, in which FIG. 1 shows a schematic illustration of a building having incorporated therein an exemplified embodiment of a device for displaying information according to the present invention.

### DETAILED DESCRIPTION OF PREFERRED EMBODIMENTS

Turning now to the drawing, and in particular to FIG. 1, there is shown a principal illustration of a building having transmitters S1, S2, S3, S4, S5 mounted in various places, for example above doors, on walls, and, in particular, in the vicinity of intersections. Data to be communicated from transmitters S1 to S5 are transferred to the transmitters S1 to S5 from a server—in the non-limiting example of FIG. 1 by means of a radio link. Transmitters S1 to S5 are thus provided additionally with reception components that enable the transmitters S1 to S5 to receive the information from the server. Of course, information may also be transferred from the server to the transmitters by way of a wired connection, without departing from the gist of the present invention. Persons skilled in the art will understand that it is certainly within the scope of the present invention to substitute a permanently installed server as communications unit with a mobile communications device, which may include, for example, a transmitter which transmits in the infrared range. In this case, the reception components of transmitters S1 to S5 likewise receive in the infrared range. Another available option is, for example, to design the communications unit as a microchip. In this case, the individual transmitters S1 to S5 are provided with readers for such a microchip. Information is then updated by inserting the microchip into the reader of the transmitter in question.

Because the information communicated from transmitters S1 to S5 is transmitted in the infrared range, the relevant portions of information can be received by receivers located approximately at positions P1 to P4. A receiver can thus receive only such information as is transmitted from the respective transmitter S1 to S5 in whose reception range the particular receiver is currently located. It can be assumed that the user of a receiver will hold the receiver in front of himself or herself. Accordingly, the user's direction of vision can be inferred. Directional information, the nature of which will depend on where the transmitter S1 to S5 is installed, can then be communicated to the receiver. This may be, for example, the information: “You have just passed the exit, which was to your LEFT. Go back about 10 m.” Another example may be: “Welcome to counter 8. Do you have sufficient cash with you? The nearest cash dispenser is in the hallway to your RIGHT”.

In the exemplified embodiment shown here, the information serves as a navigational aid for the user. If the receiver is designed accordingly, navigational aid communicated directly from the respective transmitter S1 to S5 to the receiver can be displayed. If the receiver has a memory, provision can also be made for information to be combined with earlier local information, thus improving the overall information content for the user. In a museum, for example, relations can be established between different exhibits. If a user remains standing in front of a particular exhibit for a lengthy period of time, information concerning this exhibit can be stored. Such information might, for example, be the creator of a work of art or the period during which it was created. If the user, who might by then be in another room, for example, stops in front of another work of art for longer than usual, the information about this work of art—transmitted by the relevant transmitter S1 to S5 and received by the user's receiver—can be compared with the stored information on other works of art which the user observed for longer than usual. It may then be possible for some additional information to be communicated to the user's receiver, for example that the work of art in front of which the user is currently standing originates from the same epoch as the work of art which the user observed for longer than usual earlier on. Advantageously, this additional information can be limited in this way to what the user has obviously found interesting.

The mode of operation of the device will now be described with reference to FIG. 1, whereby the user wishes to move from a starting point 1 inside a building to a destination 2. After entering the building, the user directs his receiver roughly towards one of the transmitters S1 to S5. Various packets of information are then communicated to the receiver by the individual transmitters S1 to S5. If the user is in a museum, such information can relate, for example, to the exhibits. The transmitters can also send out directions telling the user how to get from his current location to various destinations. If the user has selected a particular destination in his receiver, the most direct route (which will depend on the user's location) to this destination will be displayed. In the exemplified embodiment shown in FIG. 1, arrows were chosen to show the direction to the destination 2.

The receiver at position P1 receives information from the transmitter S1. It is to the user's advantage to then selectively display that portion of the information which describes the way to the desired destination 2. The same applies when the user comes into the range of reception of another transmitter. In FIG. 1, an arrow is shown in the receiver, telling the user to turn around. When the user has reached the destination 2, he/she is informed of this by a text display “Destination reached”.

Since the individual transmitters S1, S2, S3, S4, S5 are connected by way of a radio link to a server S, alterations in the localized information can be relayed quickly by the transmitters. Server S thus operates as central processing unit for the transmitters S1, S2, S3, S4, S5. For example, a detour made necessary by a construction site can be displayed at short notice. If a museum has a number of different exhibitions, and should one of these be especially crowded at any one time, streams of visitors can be controlled accordingly. Using a server S as central processing unit has the advantage that information in the individual transmitters S1 to S5 can be updated without delay and essentially simultaneously. In the case of a mobile communications unit, which must at least be brought into the vicinity of the transmitter S1 to S5 whose data need to be updated, the updating procedure takes correspondingly longer as different transmitters S1 to S5 transmit different information when some transmitters have already received updated data while others have not yet received updated data.

Persons skilled in the art will understand that the transmitters S1 to S5 need not necessarily be mounted inside a closed building. They can be used equally well outdoors, for example outside at organized events.

While the invention has been illustrated and described as embodied in a device for displaying information, it is not intended to be limited to the details shown since various modifications and structural changes may be made without departing in any way from the spirit of the present invention.

What is claimed as new and desired to be protected by Letters Patent is set forth in the appended claims:

What is claimed is:

1. A device for displaying information, comprising:
a portable receiver configured for receiving transmitter-specific information by wireless data transmission in an infrared range; and
a plurality of transmitters provided for transmission of the transmitter-specific information, whereby the transmitter-specific information is transmittable from the transmitters by at least one of a data transfer between the transmitters and a data transfer from a communications unit to the transmitters.

2. The device of claim 1, wherein the receiver is configured for display of the information.

3. The device of claim 1, wherein the receiver is configured for storing the information.

4. The device of claim 1, wherein the receiver has a processing unit in which the information received is processed.

5. The device of claim 1, wherein the receiver is a mobile telephone.

6. The device of claim 1, wherein the receiver is a portable computer.

7. A communications system for providing information to a user, comprising:
a plurality of transmitters positioned in different locations of a designated area and configured for receiving information;
a communications unit destined for transmission of transmitter-specific information to each of the transmitters; and
a portable receiver carried by a user and receiving information from a one of said transmitters when positioned in a reception area of said one transmitter.

8. The communications system of claim 7, and further comprising a data bus interconnecting the transmitters and transmitting data packets representing information of the plurality of transmitters and assigned respectively to the transmitters in one-to-one correspondence.

9. The communications system of claim 7, wherein the communications unit is a central processing unit which is connected to the transmitters by one of infrared communication, radio communication and wiring, and configured to instantaneously update information to be outputted by the transmitters.

10. The communications system of claim 7, wherein the reception area of one of the transmitters is separated from the reception area of another one of the transmitters, thereby ensuring that the receiver receives information from only one of the transmitters at any one time.
